(19) United States
(12) Patent Application Publication
(10) Pub. No.: US 2005/0065931 A1
(43) Pub. Date: Mar. 24, 2005

(54) Disambiguation method and apparatus

(75) Inventor: Ali Ebrahimi, Half Moon Bay, CA (US)

Correspondence Address: FITCH EVEN TABIN AND FLANNERY, 120 SOUTH LA SALLE STREET, SUITE 1600, CHICAGO, IL, 60603-3406, US

(73) Assignee: AirTx, Inc.

(21) Appl. No.: 10/665,200

(22) Filed: Sep. 19, 2003

(51) Int. Cl. G06F 15/00; G06F 7/36; G06F 7/24; G06F 7/08; G06F 17/30; G06F 7/00

(52) U.S. Cl. 707/6; 712/300

(57) ABSTRACT

A plurality of pre-identified graphic symbolic expressions are provided (31). Using only a portion of a particular graphic symbolic expression as entered (32) by a user, one can then disambiguate amongst the plurality of pre-identified graphic symbolic expressions to select (33) one of the expressions as most likely correlating to the intended complete expression entry. In a preferred embodiment, the pre-identified graphic symbolic expressions can include both expressions comprising characters and expressions comprising characters and spaces.

### TECHNICAL FIELD

This invention relates generally to graphic content entry and more particularly to disambiguation.

### BACKGROUND

In various ways and for diverse purposes people interface with numerous devices to enter graphic content such as, for example, alphanumeric characters. Such graphic content itself can comprise data to be stored, a message to be transmitted, a thought to be presented, and so forth. Many different interface mechanisms exist to facilitate the entry of such graphic content. Such mechanisms include, but are not limited to, full QWERTY or Dvorak keyboards, abbreviated keyboards (such as a keypad as found on many wireless two-way communication devices), handwriting recognizers, and speech recognizers, to name a few. Each of these devices essentially serves to receive a particular kind of user input and to translate and transpose that input into corresponding graphic content such as a series of alphanumeric characters.

In general, many of these input mechanisms (such as a full QWERTY keyboard) provide for a one-to-one correspondence between a particular discrete user input and a particular corresponding resultant graphic expression. For example, asserting a particular key on a full QWERTY keyboard will usually result in expressing only a particular corresponding alphanumeric character that correlates thereto. In this sense the resultant graphic content can be said to be predictable, as the input mechanism essentially offers no room for ambiguity regarding which graphic symbol to express in response to detection of a given particular user input.

In other cases, however, ambiguity can exist. As a simple example, and referring to FIG. 1, an abbreviated keyboard such as a keypad often provides assertable buttons that can each potentially represent a plurality of corresponding graphic symbols. For example, while some buttons 11 may correlate to only a single graphic symbol (such as the numeral “1” in this illustrative example), other buttons correlate to many corresponding alphanumeric characters. In the example depicted, for example, one button 12 can represent any of the numeral “2” and the alphabetic characters “A,” “B,” and “C” while another of the buttons 13 can represent any of the numeral “7” and the alphanumeric characters “P,” “Q,” “R, ” and “S.”

Various schemes have been proposed to attempt to resolve the ambiguity that can potentially attend the use of such a keypad when entering graphic content. Pursuant to one approach (the so-called multi-tap approach), the user must assert a given button a given number of times within a particular period of time as correlates to the relative position of the desired character within the candidate characters for a given button. For example, for the button 12 that presents the characters “2ABC,” a user would assert the button 12 three times to enter the character “B.” While generally useful to reduce the potential for ambiguity, such an approach also tends to be tedious, time consuming, and also error prone.

Another known scheme attempts to disambiguate amongst potentially ambiguous entry possibilities as can arise when only asserting each button a single time. For example, a user may assert the buttons as correspond to the numerals “2” and “8” in this order: “2,” “2,” “8.” The button for “2” correlates to the candidate characters “A,” “B,” and “C” while the button for “8” correlates to the candidate characters “T,” “U,” and “V.” Not all of the possible character permutations represented by inputting the buttons for “2, 2, 8,” however, accord with known words. For example, “2, 2, 8” matches with “ABU,” but such a character string does not match any known words in the English language. Therefore, some prior art approaches seek to leverage this situation by providing a dictionary of common words along with information regarding the statistical likelihood of each individual word being used in ordinary conversational discourse. Pursuant to this approach, when entering the buttons for “2, 2, 8” the word “ACT” will typically appear as the graphic content to be entered because “ACT” is a word found in the dictionary that both matches the input possibilities and that is statistically the word most likely to be used in comparison to all the other candidate words (such as the candidate word “CAT” which also matches the input sequence).

Such a disambiguation approach can provide some benefits. In general, however, many users find this approach to be highly error prone. That is, the word predicted by the disambiguation process is often wrong. This, in turn, requires additional input activity to attempt, one way or the other, to achieve a correct entry expression. For example, the user may be required to subsequently select a multi-tap process to enter the desired graphic content in a non-ambiguous way.

Many devices requiring or benefiting from user input are becoming smaller and/or more ubiquitous and integrated into other everyday items. This trend in turn is driving a need for simpler and smaller user interfaces. The solutions to date, however, tend to stymie rather than facilitate such trends. Smaller and more integrated input mechanisms tend to increase the likelihood of entry content ambiguity rather than to decrease such a likelihood. To the extent that present solutions often fail with respect to successfully resolving such ambiguity, such solutions fail to adequately support this presently increasing need.

### BRIEF DESCRIPTION OF THE DRAWINGS

The above needs are at least partially met through provision of the disambiguation method and apparatus described in the following detailed description, particularly when studied in conjunction with the drawings, wherein:

FIG. 1 comprises a prior art depiction of a keypad;

FIG. 2 comprises a block diagram as configured in accordance with various embodiments of the invention; and

FIG. 3 comprises a flow diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a plurality of pre-identified graphic symbolic expressions are provided wherein a given graphic symbolic expression can include any of a plurality of characters and a combination of characters and spaces that separate such characters. When a user enters input that corresponds to only a portion of a particular intended graphic symbolic expression (as occurs, for example, while the user enters information and prior to the completion of that entry process), that portion is then used to disambiguate amongst the plurality of pre-identified graphic symbolic expressions to thereby permit selection of a particular one of the graphic symbolic expressions as likely correlating to the particular graphic symbolic expression.

Such an approach offers great flexibility. In particular, such an approach permits disambiguation not only on a word-by-word basis, but more powerfully permits disambiguation based upon multi-character strings that include one or more spaces. For example, this approach permits disambiguation on a multi-word-by-multi-word basis. This, in turn, permits disambiguation using expressions that comprise partial sentences, complete sentences, and even multiple sentences. Although some or all of the pre-identified graphic symbol expressions can comprise user independent expressions (such as, for example, common phrases, sentences, or paragraphs), in a preferred approach at least some of the pre-identified graphic symbol expressions are more user specific. Highly efficient, timely, and accurate prediction results often ensue when combining a given user's typical wording, phrases, statements, and longer expressions with the multi-word disambiguation process described herein.

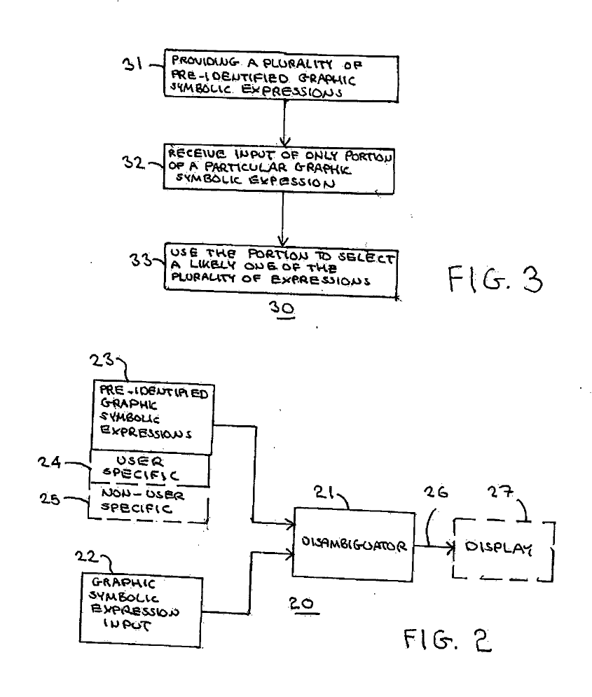

Referring now to the drawings, and in particular to FIG. 2, a disambiguation platform 20 suitable to support a preferred approach will be described. This platform 20 can serve as an independent entity if desired but will more preferably comprise a part of some larger mechanism such as, for example, a cellular telephone. This disambiguation platform 20 comprises a disambiguator 21, a graphic symbolic expression input 22, and a plurality of pre-identified graphic symbolic expressions 23.

The disambiguator 21 can be comprised of a fixed-purpose platform or a fully or partially programmable platform as best suits the needs of a given application. For example, the programmable controller of a handheld wireless two-way communications device can be readily configured to provide the requisite disambiguation functionality set forth herein.

The graphic symbolic expression input 22 can similarly be comprised of any of a wide variety of input mechanisms. A non-exhaustive short listing would include full keyboards, abbreviated keyboards (such as a keypad), handwriting recognizers, and speech recognizers (it will be appreciated and understood by those skilled in the art that the full or abbreviated keyboards can comprise any of a mechanical keyboard or a soft keyboard such as a touch-screen based keyboard and further that such keyboards will tend to have at least some user selectable keys that have one or more alphanumeric characters or other graphic symbols assigned thereto).

A user will preferably use the graphic symbolic expression input 22 to present, usually in seriatim fashion, discrete inputs that are intended to correlate to the characters of an intended graphic symbolic expression such as a word, a series of words, and/or presentation of other linguistic or non-linguistic elements. As used herein, it should be understood that a given graphic symbolic expression can include any of an individual character (such as an alphanumeric representation such as “a,” “A,” or “3”), a plurality of characters (such as a combination of alphanumeric representations such as “cat”), or a combination of characters and spaces that separate such characters (such as “a cat”). In turn, it should be understood that a “character” can comprise any linguistic element (such as a letter or number having a speech related corollary) or non-linguistic element (such as ideograms (like Japanese katakana characters or other concept-imparting symbols like the ubiquitous smiley face), punctuation marks, and so forth).

In turn, it will be understood that the pre-identified graphic symbolic expressions 23 are themselves comprised of any such characters and spaces in any relevant order and configuration. Such expressions 23 can include complete or partial words as well as multi-word phrases, sentences, and multi-sentence expressions. In a preferred embodiment, such expressions 23 can also include such other expressions as may be used by a given corresponding individual. For example, if a particular individual often uses one or more non-linguistic characters when conveying messages (for example, during email discourse), then such characters are also a suitable expression (alone or in combination with other characters as may be appropriate and/or as may accord with the user's own historical behavior) to include in the plurality of pre-identified graphic symbolic expressions 23.

Such pre-identified expressions 23 can include user specific expressions 24, non-user specific expressions 25, or both as best suits the needs of a given application. User specific expressions can be pre-identified in a variety of ways. For example, an interview technique can be used to extract such information from a given user. In a preferred embodiment, however, a personal language model for a given individual can be developed by accessing and analyzing various documents or other graphic symbolic expressions as were previously authored by such individual. For example, email records for such a user can be accessed and analyzed to identify words, expressions and phrases, sentences, and even complete paragraphs or “messages” that the user tends to employ. Such an approach even permits non-dictionary words (including abbreviations, slang, acronyms, proper names, foreign language words, and so forth) to be readily cataloged and made available in the pre-identified graphic symbolic expressions 23. (Various ways to develop and employ such a personal language model are set forth in co-pending U.S. patent application Ser. No. ______ entitled Alphanumeric Information Input Method and filed on ______, 2002, the contents of which are incorporated herein by this reference.)

The pre-identified graphic symbolic expressions 23 are disposed in one or more memories. Such memories can be remote to the disambiguator 21 as illustrated or can be partially or wholly integral to the disambiguator as appropriate to suit the requirements of a given setting. It is also possible to dispose such memories considerably remote from the disambiguator 21. For example, some or all of the pre-identified graphic symbolic expressions 23 can reside on a server that the disambiguator 21 accesses as a client via one or more intervening networks in accordance with well understood prior art technique.

So configured, the disambiguator 21 can employ disambiguation techniques that essentially comprise comparing the incomplete entries of a user via the graphic symbolic expression input 22 against the contents of the pre-identified graphic symbolic expressions 23. Instead of only comparing a potentially incomplete word as entered by a user against other single word entries that match the present entry to facilitate selecting a particular disambiguated word, however, multiple word expressions (and even expressions that include non-linguistic content) can be considered and subjected to a similar kind of statistical-rate-of-use selection analysis. The resultant selected output 26 can then be provided and used as appropriate. For example, this output 26 can be provided to an optional display 27 (such as a cathode ray tube display, a liquid crystal display, and so forth) to present the selected expression to a user.

Referring now to FIG. 3, a disambiguation process 30 can use a platform such as the one described above (or any other mechanism as will support the described functionality) to effect a process whereby a plurality of pre-identified graphic symbolic expressions are provided 31. As noted, in a preferred embodiment, at least some of these pre-identified graphic symbolic expressions comprise user-specific expressions as reflect the personal language usage preferences exhibited by the user. Upon receiving 32 input from a user of only a portion of a particular graphic symbolic expression, the process 30 uses 33 that portion to select a likely one of the plurality of pre-identified graphic symbolic expressions as likely correlating to the particular graphic symbolic expression that the user intends to enter. Pursuant to this process 30, this selection process comprises using the entered information to disambiguate amongst the plurality of pre-identified graphic symbolic expressions to thereby select a particular graphic symbolic expression that may well comprise a multi-word linguistic expression, a partial-sentence multi-word linguistic expression, a complete-sentence multi-word linguistic expression, or even a multi-sentence linguistic expression.

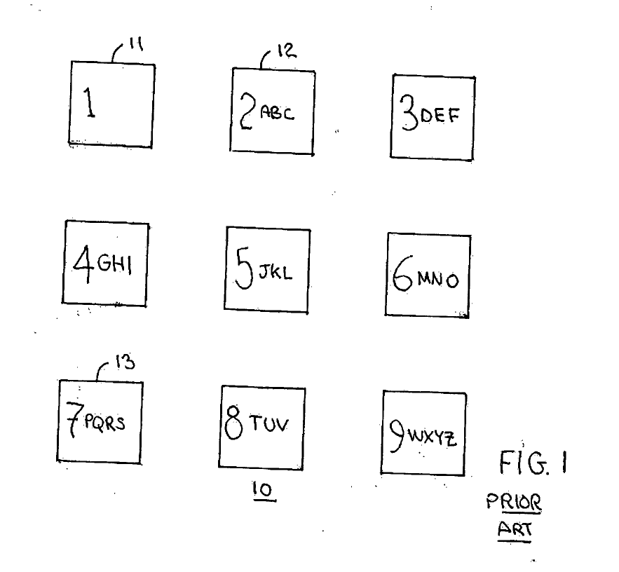

As one example, the pre-identified expressions may include the graphic symbolic expression “Dun & Bradstreet.” Upon entering the buttons on a standard keypad (as illustrated in FIG. 1) for “3” and “8,” this process 30 can select the multi-word expression “Dun & Bradstreet” notwithstanding that only two characters have been entered so far by the user and notwithstanding that the selected expression includes an ampersand “&.” (This example presumes, of course, that the selected expression is otherwise statistically favored at the time of disambiguation.)

As another example, the pre-identified expressions may include the graphic symbolic expression “cul8r 2nite.” Upon entering the buttons on a standard keypad (again as illustrated in FIG. 1) for “2” and “8,” this process 30 can select the multi-word expression “cul8r 2nite” notwithstanding that only two characters have been entered so far by the user and notwithstanding that neither “cul8r” or “2nite” comprises an actual word to be found in an ordinary dictionary (in this example, “cul8r” is often used in short messages to represent “see you later” and “2nite” similarly represents “tonight”). (This example presumes that the selected expression is otherwise available to the process 30 as part of, for example, a personal language model for the user or a group model for a group to which the user belongs.)

Such a disambiguation process can occur with each entry by the user, including of course the initial entry, if desired. It would also be possible to further inform the disambiguation process with other ancillary but relevant information. For example, when the process 30 is apprised that the user is preparing the body of an email message, this information may prompt the use of altered statistics regarding usage of the contents of the pre-identified graphic symbolic expressions. That is, the user may favor certain words and expressions more when writing an email than when performing some other function and such preferences can be taken into account when disambiguating amongst the candidate expressions.

Facilitating multi-word (and indeed phrase-based, expression-based, sentence-based, and even paragraph-based or paragraphs-based) disambiguation in this manner can greatly facilitate improved accuracy with respect to accurately predicting the intended input of a given user. This, in turn, can significantly reduce the number of input entries that the user must employ in order to effect the entry of such content. As a result, users are able to input a greater quantity of information in a shorter period of time than one ordinarily expects with standard disambiguation techniques. Furthermore, these benefits are attained notwithstanding the use of small, inherently ambiguous input mechanisms such as abbreviated keypads, speech recognizers, handwriting recognizers, and the like.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, the pre-identified graphic symbolic expressions can include group-specific expressions. That is, a give user may belong to one or more groups (such as a professional group, a shared-interest group, a common-experiences group, and so forth) that tends to make use of particular words or expressions to a greater extent than the general populace. For example, a user who practices medicine may well be expected to use medical terminology more frequently, at least during professional communications, than other members of the general population. By including group-specific expressions and statistics regarding their likelihood of usage the disambiguation-by-prediction capabilities of these embodiments may be enhanced at least for some users.

1. A method comprising:
providing a plurality of pre-identified graphic symbolic expressions, wherein a graphic symbolic expression includes any of:
a plurality of characters; and
a combination of characters and spaces that separate characters;
receiving input that corresponds to only a portion of a particular graphic symbolic expression;
using the portion of the particular graphic symbolic expression to disambiguate amongst the plurality of pre-identified graphic symbolic expressions to thereby select a selected graphic symbolic expression as likely correlating to the particular graphic symbolic expression.

2. The method of claim 1 wherein a graphic symbolic expression can further include any of:
an individual character;
a plurality of characters; and
a combination of characters and spaces that separate characters.

3. The method of claim 1 wherein a character can comprise any of:
a linguistic element;
a non-linguistic element.

4. The method of claim 2 wherein a linguistic element can comprise any of:
an alphanumeric character;
an idiogram;
a punctuation mark.

5. The method of claim 1 wherein providing a plurality of pre-identified graphic symbolic expressions comprises providing a plurality of non-user specific pre-identified graphic symbolic expressions.

6. The method of claim 1 wherein providing a plurality of pre-identified graphic symbolic expressions comprises providing a plurality of user specific pre-identified graphic symbolic expressions.

7. The method of claim 1 wherein providing a plurality of pre-identified graphic symbolic expressions comprises providing a plurality of:
non-user specific pre-identified graphic symbolic expressions; and
user specific pre-identified graphic symbolic expressions.

8. The method of claim 1 wherein receiving input comprises receiving input via at least one of:
a full keyboard;
an abbreviated keyboard;
a handwriting recognizer; and
a speech recognizer.

9. The method of claim 8 wherein either of the full keyboard and abbreviated keyboard can comprise any of:
a mechanical keyboard; and
a soft keyboard.

10. The method of claim 1 wherein using the portion of the particular graphic symbolic expression to disambiguate amongst the plurality of pre-identified graphic symbolic expressions to thereby select a selected graphic symbolic expression as likely correlating to the particular graphic symbolic expression comprises using the portion of the particular graphic symbolic expression to disambiguate amongst the plurality of pre-identified graphic symbolic expressions to thereby select a selected graphic symbolic expression that comprises a multi-word linguistic expression.

11. The method of claim 1 wherein using the portion of the particular graphic symbolic expression to disambiguate amongst the plurality of pre-identified graphic symbolic expressions to thereby select a selected graphic symbolic expression as likely correlating to the particular graphic symbolic expression comprises using the portion of the particular graphic symbolic expression to disambiguate amongst the plurality of pre-identified graphic symbolic expressions to thereby select a selected graphic symbolic expression that comprises a partial-sentence multi-word linguistic expression.

12. The method of claim 1 wherein using the portion of the particular graphic symbolic expression to disambiguate amongst the plurality of pre-identified graphic symbolic expressions to thereby select a selected graphic symbolic expression as likely correlating to the particular graphic symbolic expression comprises using the portion of the particular graphic symbolic expression to disambiguate amongst the plurality of pre-identified graphic symbolic expressions to thereby select a selected graphic symbolic expression that comprises a complete-sentence multi-word linguistic expression.

13. The method of claim 1 wherein using the portion of the particular graphic symbolic expression to disambiguate amongst the plurality of pre-identified graphic symbolic expressions to thereby select a selected graphic symbolic expression as likely correlating to the particular graphic symbolic expression comprises using the portion of the particular graphic symbolic expression to disambiguate amongst the plurality of pre-identified graphic symbolic expressions to thereby select a selected graphic symbolic expression that comprises a multi-sentence multi-word linguistic expression.

14. The method of claim 1 wherein using the portion of the particular graphic symbolic expression to disambiguate amongst the plurality of pre-identified graphic symbolic expressions to thereby select a selected graphic symbolic expression as likely correlating to the particular graphic symbolic expression comprises using the portion of the particular graphic symbolic expression to disambiguate amongst the plurality of pre-identified graphic symbolic expressions to thereby select a selected graphic symbolic expression that comprises a multi-word linguistic expression wherein at least one word of the multi-word linguistic expression comprises at least one of:
an abbreviation;
an ideogram;
at least one numeric character; and
a punctuation mark.

15. A method for use with an abbreviated keyboard wherein at least some keys ambiguously represent multiple graphic symbolic characters, comprising:
providing a plurality of pre-identified graphic symbolic expressions, wherein a graphic symbolic expression includes any of:
a plurality of characters; and
a combination of characters and spaces that separate characters;
and wherein the plurality of pre-identified graphic symbolic expressions includes at least one user specific pre-identified graphic symbolic expressions;
receiving input via the abbreviated keyboard that corresponds to only a portion of a user-intended particular graphic symbolic expression and that ambiguously corresponds to a plurality of possible graphic symbolic expressions;
using the input and the plurality of pre-identified graphic symbolic expressions to thereby disambiguate amongst the plurality of possible graphic symbolic expressions to provide a selected graphic symbolic expression as likely correlating to the user-intended graphic symbolic expression.

16. The method of claim 15 wherein:
a character can comprise any of:
a linguistic element; and
a non-linguistic element;
and wherein a linguistic element can comprise any of:
an alphanumeric character;
an idiogram; and
a punctuation mark.

17. The method of claim 15 wherein using the input and the plurality of pre-identified graphic symbolic expressions to thereby disambiguate amongst the plurality of possible graphic symbolic expressions to provide a selected graphic symbolic expression as likely correlating to the user-intended graphic symbolic expression comprises using the input and the plurality of pre-identified graphic symbolic expressions to thereby disambiguate amongst the plurality of possible graphic symbolic expressions to provide a selected graphic symbolic expression that comprises a multi-word linguistic expression.

18. The method of claim 15 wherein using the input and the plurality of pre-identified graphic symbolic expressions to thereby disambiguate amongst the plurality of possible graphic symbolic expressions to provide a selected graphic symbolic expression as likely correlating to the user-intended graphic symbolic expression comprises using the input and the plurality of pre-identified graphic symbolic expressions to thereby disambiguate amongst the plurality of possible graphic symbolic expressions to provide a selected graphic symbolic expression that comprises a partial-sentence multi-word linguistic expression.

19. The method of claim 15 wherein using the input and the plurality of pre-identified graphic symbolic expressions to thereby disambiguate amongst the plurality of possible graphic symbolic expressions to provide a selected graphic symbolic expression as likely correlating to the user-intended graphic symbolic expression comprises using the input and the plurality of pre-identified graphic symbolic expressions to thereby disambiguate amongst the plurality of possible graphic symbolic expressions to provide a selected graphic symbolic expression that comprises a complete-sentence multi-word linguistic expression.

20. The method of claim 15 wherein using the input and the plurality of pre-identified graphic symbolic expressions to thereby disambiguate amongst the plurality of possible graphic symbolic expressions to provide a selected graphic symbolic expression as likely correlating to the user-intended graphic symbolic expression comprises using the input and the plurality of pre-identified graphic symbolic expressions to thereby disambiguate amongst the plurality of possible graphic symbolic expressions to provide a selected graphic symbolic expression that comprises a multi-sentence multi-word linguistic expression.

21. The method of claim 15 wherein using the input and the plurality of pre-identified graphic symbolic expressions to thereby disambiguate amongst the plurality of possible graphic symbolic expressions to provide a selected graphic symbolic expression as likely correlating to the user-intended graphic symbolic expression comprises using the input and the plurality of pre-identified graphic symbolic expressions to thereby disambiguate amongst the plurality of possible graphic symbolic expressions to provide a selected graphic symbolic expression that comprises a multi-word linguistic expression wherein at least one word of the multi-word linguistic expression comprises at least one of:
an abbreviation;
an ideogram;
at least one numeric character; and
a punctuation mark.

22. An apparatus comprising:
a graphic symbol entry device;
at least one memory containing a plurality of pre-identified graphic symbolic expressions, wherein a graphic symbolic expression includes any of:
a plurality of characters; and
a combination of characters and spaces that separate characters;
a disambiguator operably coupled to:
the graphic symbol entry device to facilitate receiving a portion of a particular graphic symbolic expression as entered by a user using the graphic symbol entry device; and
the at least one memory;
and having an output comprising a given one of the pre-identified graphic symbolic expressions as disambiguated from others of the plurality of pre-identified graphic symbolic expressions as based upon the portion of the particular graphic symbolic expression.

23. The apparatus of claim 22 wherein the graphic symbol entry device comprises a keypad having keys, wherein at least some of the keys have a plurality of differing alphanumeric characters assigned thereto.

24. The apparatus of claim 22 wherein the apparatus comprises a cellular telephone.

25. The apparatus of claim 22 and further comprising a display having an input operably coupled to the output of the disambiguator.

26. The apparatus of claim 22 wherein the disambiguator comprises disambiguation means for disambiguating amongst the plurality of pre-identified graphic symbolic expressions as a function, at least in part, of the portion of the particular graphic symbolic expression.

27. The apparatus of claim 22 wherein the memory is disposed integral to the disambiguator.

28. The apparatus of claim 22 wherein the memory is disposed remote to the disambiguator.
